(19) United States
(12) Patent Application Publication
(10) Pub. No.: US 2004/0246579 A1
(43) Pub. Date: Dec. 9, 2004

(54) Optical isolator

(76) Inventors: Christopher James Griffin, Aurora, CO (US); Harvey Lawrence Wagner, Macungie, PA (US)

Correspondence Address: Lester H. Birnbaum, 6308 Sauterne Drive, Macungie, PA, 18062, US

(21) Appl. No.: 10/457,275

(22) Filed: Jun. 9, 2003

(51) Int. Cl. G02B 5/30

(52) U.S. Cl. 359/484; 359/486; 372/703

(57) ABSTRACT

An optical device and method of manufacture are disclosed. The optical isolator includes a substrate comprising a magnetic material such as a Garnet. Respective sets of essentially parallel conductors are selectively formed on both major surfaces of the substrate. The set on one surface is at a selected angle with respect to the set on the other surface.

### FIELD OF THE INVENTION

The present invention relates generally to optical components and, more particularly, to an optical isolator

### BACKGROUND OF THE INVENTION

Optical isolators are used in present optical systems to prevent back reflection to sensitive components such as lasers. Typical isolators employ an input polarizer, a non-reciprocal polarization rotator (i.e. Faraday Rotator), an output polarizer, and a magnet to pole the rotator. An improvement in isolator design utilizes a latching garnet material for the rotator. The latching garnet is a material whose optical properties remain fixed after initial exposure to a magnetic field so that a magnet does not need to be included in the final isolator package. This design reduces the number of components and also allows the isolators to be placed close together in an optical system without the concern of interfering magnetic fields.

While the latching garnet design is advantageous, the isolator still needs three components that need to be assembled and packaged for use. It would be desirable to further reduce the number of components, thereby reducing the cost of assembling the package.

### SUMMARY OF THE INVENTION

The present invention is an optical isolator comprising a substrate of a magnetic material, the substrate having two major surfaces. Formed on both major surfaces are respective sets of essentially parallel conductors, the set on one surface being at a selected angle with respect to the set on the other surface.

In accordance with another aspect, the invention is a method for forming an optical isolator comprising providing a substrate comprising a magnetic material and having two major surfaces. Respective sets of essentially parallel conductors are selectively formed on both major surfaces, the set on one surface being at a selected angle with respect to the set on the other surface. It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice in the industry, the various features of the drawing are not to scale. On the contrary, the dimensions of the various features are arbitrarily expanded or reduced for clarity. Included in the drawing are the following figures:

FIG. 1 is a perspective view of a component in accordance with an embodiment of the invention;

FIG. 2 is a schematic perspective view of the component of FIG. 1 in a portion of an optical system illustrating certain principles of operation of the invention; and

FIGS. 3-6 are cross sectional views of the component of FIG. 1 during various stages of fabrication in accordance with an embodiment of the method aspects of the invention.

### DETAILED DESCRIPTION OF THE INVENTION

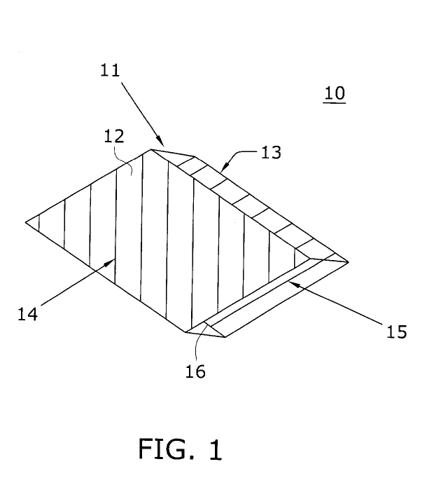

Referring now to the drawing, wherein like reference numerals refer to like elements throughout, FIG. 1 is a perspective view of a component, 10, used in the isolator according to one embodiment. The component includes a substrate, 11, comprising a magnetic material, preferably a non-reciprocal magnetically latched material such as a Garnet. The substrate includes two major surfaces, a front surface, 12, and a back surface, 13. The front surface, 12, includes a set of metallic conductors, e.g., 14, formed in an essentially parallel configuration and, in this example, at an angle of approximately 45 degrees with respect to an edge, 16, of the substrate. In this example, the conductors were aluminum or gold, but could be any conductive material. The conductors could be formed directly on the surface or on an insulating layer on the surface. In order to keep optical losses low, it is desirable that the conductors be kept narrow with respect to the wavelength (λ) transiting the device, i.e., less than λ/10, and thin, i.e., less than λ/10. It is also desirable that the center to center spacing between the conductors (pitch) be less than λ/2, but at least twice the width of the conductors. The black surface, 13, includes a set of conductors, e.g. 15, which can be identical to the set on the front surface except for the fact that the back surface conductors are essentially parallel to the edge, 16. Thus, the conductors on the back surface in this example are at an angle or approximately 45 degrees with respect to the conductors on the front surface. This angle can be varied for other designs.

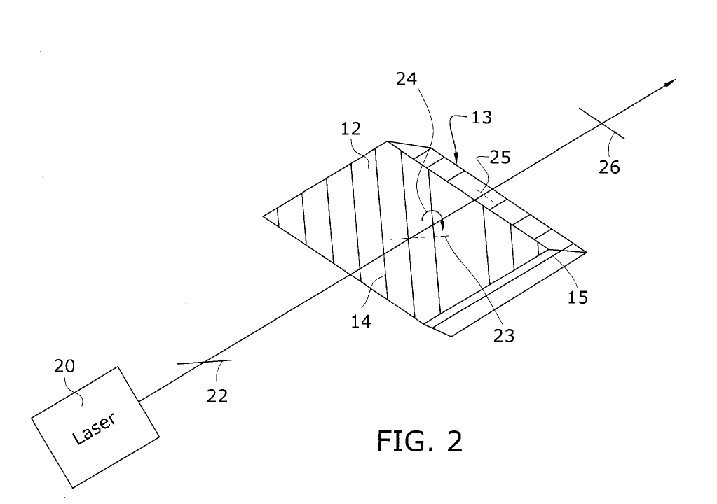

FIG. 2 illustrates schematically how the component operates in a typical system. Light from a laser, 20, typically has polarized light, with the polarization direction illustrated by line 22 in the Fig. Preferably, the direction of polarization is orthogonal to the conductors, 14. The light is made incident on the front surface, 12, of the component, 10. The presence of the conductors, e.g., 14, on the front surface permits light which is polarized in an orthogonal direction to the conductors, 14, to be transmitted, line 23, while light which is polarized in a parallel direction is reflected. The Garnet material of the substrate, 11, causes a 45 degree rotation of the polarization direction in a clockwise direction, as illustrated by solid arrow, 24. This rotation results in the light reaching the back surface, 13, having a polarization direction, illustrated by broken line 25, which is essentially orthogonal to the conductors, e.g., 15 on that surface. The light, therefore, passes through the back surface and is transmitted to the next component (not shown) with the polarization illustrated by solid line, 26. If the light were to be reflected back, it would not be able to pass through the component, 10, due to the fact that the Garnet would further rotate the polarization in a clockwise direction and the polarization would then be parallel to the conductors, 14, on the front surface.

Thus, an optical isolator can be formed according to the invention with only a single piece-part, 10, resulting in reduced handling and assembly costs.

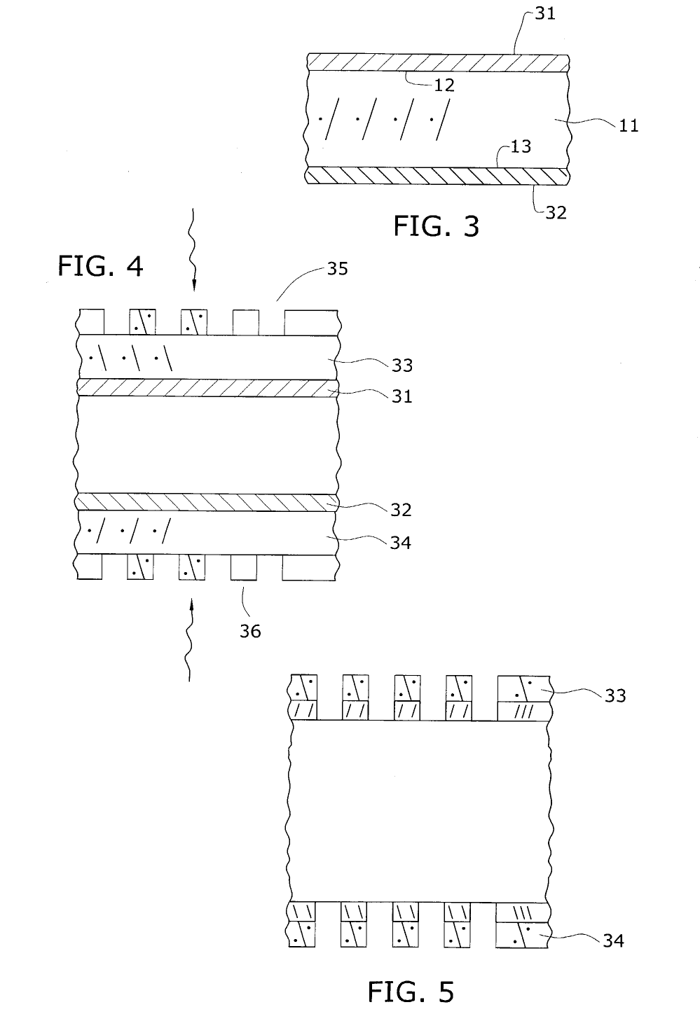

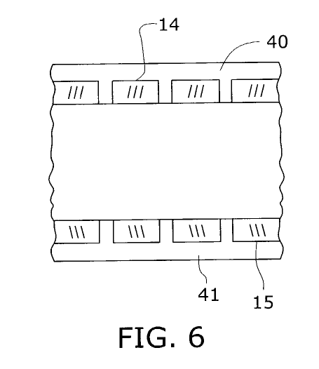

A typical component, 10, can be fabricated in according to the embodiment illustrated in FIGS. 3-6. As illustrated in FIG. 3, thin metal layers, 31 and 32, are deposited on essentially the entire surfaces of the front and back surfaces, 12 and 13, respectively, of the substrate, 11. The metal layers can be, for example, aluminum or gold, and can be deposited by sputtering or other evaporative deposition techniques. The substrate can be poled according to standard techniques to perform the desired rotation either before or after the deposition of the metal layers. As illustrated in FIG. 4, standard photoresist layers 33 and 34, are deposited by standard techniques over essentially the entire surfaces of the metal layers, 31 and 32, respectively. This is followed by placement of mask material layers, 35 and 36, over the surface of the photoresist layers, 33 and 34, respectively. The photoresist layers, 33 and 34, are selectively exposed to light through the masks. The mask layers are removed, and an etchant is applied which selectively removes the portions of the photoresist previously exposed to the light to produce the structure of FIG. 5. As further shown in FIG. 5, the portions of the metal layers, 31 and 32, not covered by the photoresist masks are then etched off the substrate. The photoresist layers, 33 and 34, are then stripped off resulting in the component, 10, with the desired conductors, e.g., 14 and 15, on the major surfaces. If desired, optically transparent passivation layers, 40 and 41, could be deposited over the two major surfaces including the conductors as illustrated in FIG. 6.

Thus the component, 10, could be fabricated using standard integrated circuit photolithographic techniques. Also, the above processing can be performed on a large Garnet substrate that could then be diced up to form individual components, 10, thus further reducing the cost of manufacture.

Although the invention has been described with reference to exemplary embodiments, it is not limited to those embodiments. For example, the conductors could be formed by selective deposition, rather than by selective etching. The isolator component, 10, could be packaged individually or with other components such as lasers, photodetectors, or optical amplifiers. Also, the conductors could be formed simultaneously or sequentially on the two surfaces. Thus, the appended claims should be construed to include other variants and embodiments of the invention which may be made by those skilled in the art without departing from the true spirit and scope of the present invention.

What is claimed:

1. An optical isolator comprising:
a substrate of a magnetic material, the substrate having two major surfaces; and
sets of essentially parallel conductors formed on the respective major surfaces, the set on one surface being at a selected angle with respect to the set on the other surface.

2. The isolator according to claim 1 wherein the magnetic material comprises a non-reciprocal magnetically latched material.

3. The isolator according to claim 2 wherein the magnetic material comprises a garnet material.

4. The isolator according to claim 1 wherein the conductors have a width less than λ/10 where λ is the wavelength of light to be incident on the isolator.

5. The isolator according to claim 1 wherein the conductors have a pitch less than λ/2, where λ is the wavelength of light to be incident on the isolator.

6. The isolator according to claim 1 wherein the selected angle is approximately 45 degrees.

7. The isolator according to claim 1 wherein the conductors have a thickness less than λ/10 where λ is the wavelength of light to be incident on the isolator.

8. The isolator according to claim 1 wherein the isolator further comprises a passivation layer formed over the major surfaces and conductors.

9. The isolator according to claim 1 wherein the conductors are selected from aluminum and gold.

10. A method of fabricating an optical isolator comprising the steps of:
providing a substrate comprising a magnetic material and having two major surfaces; and
selectively forming on both major surfaces respective sets of essentially parallel conductors, the set on one surface being at a selected angle with respect to the set on the other surface.

11. The method according to claim 10 wherein the conductors are formed by selective etching using a photoresist mask.

12. The method according to claim 10 wherein the conductors are formed with a width of less than λ/10 where λ is the wavelength of light to be incident on the isolator.

13. The method according to claim 10 wherein the conductors are formed with a thickness of less than λ/10 where λ is the wavelength of light to be incident on the isolator.

14. The method according to claim 10 wherein the conductors are formed with a pitch of less than λ/2 where λ is the wavelength of light to be incident on the isolator.

15. The method according to claim 10 wherein the conductors comprise a material selected from aluminum and gold.

16. The method according to claim 10 wherein the sets of conductors are formed at an angle of approximately 45 degrees.

17. The method according to claim 10 further comprising the step of forming a passivation layer the major surfaces and the conductors.
